(19) United States
(12) Patent Application Publication
(10) Pub. No.: US 2024/0371390 A1
(43) Pub. Date: Nov. 7, 2024

(54) INFORMATION PROCESSING DEVICE, INFORMATION PROCESSING METHOD, AND PROGRAM

(71) Applicant: SONY GROUP CORPORATION, TOKYO (JP)

(72) Inventor: NAOYA TAKAHASHI, TOKYO (JP)

(21) Appl. No.: 18/689,216

(22) PCT Filed: Feb. 16, 2022
(86) PCT No.: PCT/JP2022/006054

§ 371 Date: Mar. 5, 2024

(30) Foreign Application Priority Data
Sep. 24, 2021 (JP) 2021-155973

(51) Int. Cl. G10L 21/028

(52) U.S. Cl. CPC G10L 21/028

(57) ABSTRACT

For example, the performance of sound source separation is improved. Provided is an information processing device that includes a sound source separation unit that performs sound source separation on a mixed sound signal obtained by mixing a plurality of sound source signals and further mixing a perturbation optimized to improve performance of the sound source separation.

### TECHNICAL FIELD

The present disclosure relates to an information processing device, an information processing method, and a program.

### BACKGROUND ART

Various proposals have been made regarding sound source separation, such as deep neural network (DNN)-based sound source separation (see, for example, Patent Document 1 below).

### CITATION LIST

### Patent Document

Patent Document 1: WO 2018/047643 A

### SUMMARY OF THE INVENTION

### Problems to be Solved by the Invention

In this field, it is desired to improve the accuracy of sound source separation.

An object of the present disclosure is to provide an information processing devices, an information processing method, and a program that improve the accuracy of sound source separation.

### Solutions to Problems

The present disclosure is, for example, an information processing device that includes a sound source separation unit that performs sound source separation on a mixed sound signal obtained by mixing a plurality of sound source signals and further mixing a perturbation optimized to improve performance of the sound source separation.

The present disclosure is, for example, an information processing device that includes a perturbation acquisition unit that acquires a perturbation to be added to a mixed sound signal in which a plurality of sound source signals is mixed. The perturbation acquisition unit acquires the perturbation by learning so as to minimize a separation error based on a difference between a predetermined sound source signal and a separation signal obtained by sound source separation from the mixed sound signal.

The present disclosure is, for example, an information processing method in which a sound source separation unit performs sound source separation on a mixed sound signal obtained by mixing a plurality of sound source signals and further mixing a perturbation optimized to improve performance of the sound source separation.

The present disclosure is, for example, a program for causing a computer to execute an information processing method in which a sound source separation unit performs sound source separation on a mixed sound signal obtained by mixing a plurality of sound source signals and further mixing a perturbation optimized to improve performance of the sound source separation.

### BRIEF DESCRIPTION OF DRAWINGS

FIG. 1 is a diagram for describing an outline of a system according to an embodiment.

FIG. 2 is a diagram for describing an outline of a first embodiment.

FIG. 3 is a block diagram illustrating a configuration example of a reproduction device according to the first embodiment.

FIG. 4 is a diagram for describing an application example of a second embodiment.

FIG. 5 is a diagram for describing an application example of the second embodiment.

FIG. 6 is a diagram for describing an application example of the second embodiment.

FIG. 7 is a diagram for describing an outline of processing performed in a third embodiment.

FIG. 8 is a diagram for describing a configuration example of a system according to the third embodiment.

FIG. 9 is a view for describing an example of a user interface (UI) applicable to the present disclosure.

### MODE FOR CARRYING OUT THE INVENTION

Embodiments and the like of the present disclosure will be described below with reference to the drawings. Note that the description will be given in the following order.
<Background of Present Disclosure>
<First Embodiment>
<Second Embodiment>
<Third Embodiment>
<Modification>

The embodiments and the like described below are preferred specific examples of the present disclosure, and the content of the present disclosure is not limited to the embodiments and the like.

### Background of Present Disclosure

First, the background of the present disclosure will be described in order to facilitate understanding of the present disclosure. The performance of DNN-based sound source separation has been improved and utilized for many services such as up-mixing in offline processing. However, in online (real-time) processing in an edge device (reproduction side terminal) such as a smartphone, it is difficult to perform high-quality sound source separation and separation into a large number of sound sources due to constraints such as a calculation amount, and application examples are also limited.

In addition, when sound source separation application software operable in many devices such as smartphones is distributed, it is necessary to design a sound source separation algorithm so that the sound source separation algorithm can operate even in a (low-end) device having poor calculation resources. Even in such a case, it is desirable to improve the performance of sound source separation.

Furthermore, in an object audio such as 360 Reality Audio (RA) capable of providing a feeling that sound is dammed from all directions, in a case where a multi-channel signal is to be streamed, a communication amount becomes enormous as the number of sound sources (channels) increases. Although there are codecs for multi-channel object audio such as Moving Picture Experts Group (MPEG)-H, a communication amount is still large, and furthermore, a specific decoder is required, so that reproduction cannot be performed by a non-compatible decoder. Therefore, it is preferable to be able to suppress the communication amount at the time of transmission while improving the performance of sound source separation. Based on the above, the contents of the present disclosure will be described in detail with reference to the embodiments.

### First Embodiment

### [Configuration Example of Reproduction System]

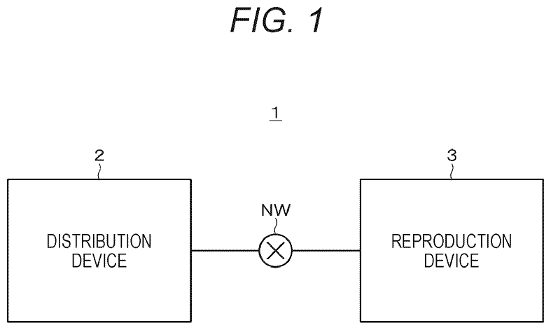

FIG. 1 illustrates a configuration example of a reproduction system (reproduction system 1) according to a first embodiment. The reproduction system 1 includes a distribution device 2 and a reproduction device 3 connected via a network NW. There may be a plurality of distribution devices 2 and a plurality of reproduction devices 3. The distribution device 2 and the reproduction device 3 correspond to an example of an information processing device. A typical example of the network NW is the Internet, but the network NW may be any network such as a local area network (LAN), Bluetooth (registered trademark), and Wi-Fi (registered trademark). In addition, the distribution device 2 and the reproduction device 3 may be connected by wire. In the present embodiment, the reproduction device 3 will be described as a smartphone, but the reproduction device 3 may be any device such as a personal computer, a hearable device such as a headphone and an earphone, and another wearable device.

### [Outline of Embodiment]

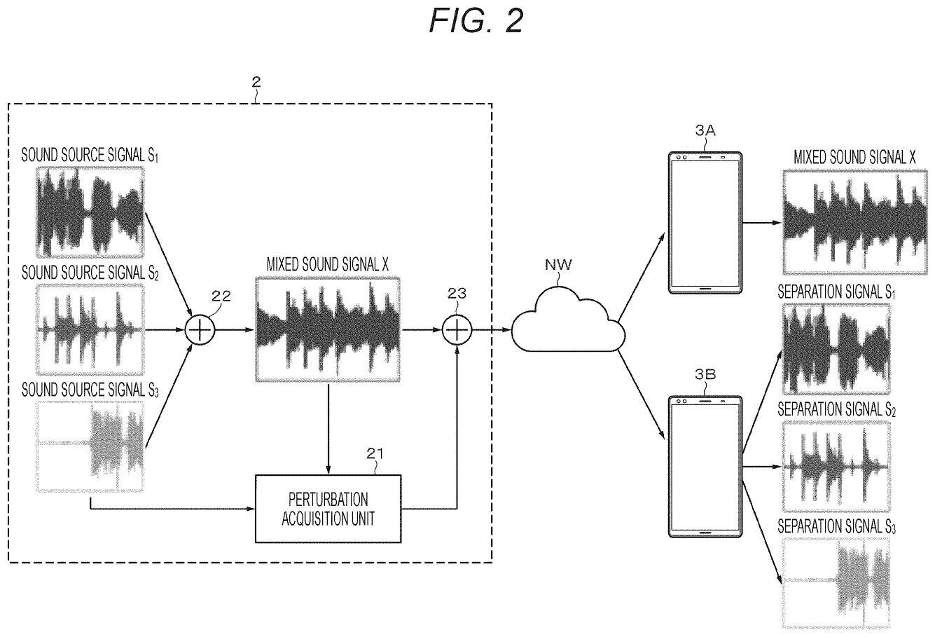

FIG. 2 is a diagram for describing an outline of the embodiment. FIG. 2 illustrates one distribution device 2, two reproduction devices (reproduction device 3A and 3B), and waveforms corresponding to respective audio signals.

The distribution device 2 includes a perturbation acquisition unit 21, an adder 22, and an adder 23. For example, the distribution device 2 generates a mixed sound signal X by adding three sound source signals S₁ to S₃ by the adder 22 using a known method. Each of the sound source signals S₁ to S₃ is, for example, a vocal signal, a signal corresponding to a drum, or a signal corresponding to a guitar, but is not limited thereto. Furthermore, the mixed sound signal X may be a signal in which more sound source signals are mixed.

The perturbation acquisition unit 21 acquires (generates) a perturbation n that is a minute signal by performing machine learning, which will be described later. The perturbation acquisition unit 21 obtains the perturbation η using, for example, each sound source signal, its mixed sound signal, and information of a sound source separation model. The perturbation η is a kind of noise for improving performance of sound source separation processing by a sound source separator (in the present specification, it means a function (algorithm) that performs sound source separation, and may be referred to as a sound source separation model). In addition, to improve the performance of the sound source separation processing means to set the sound quality of the sound source signal subjected to the sound source separation (also referred to as a separation signal as appropriate) to a certain level or more.

The adder 23 adds the perturbation η acquired by the perturbation acquisition unit 21 to the mixed sound signal X. The mixed sound signal X to which the perturbation η is added is transmitted to the reproduction devices 3A and 3B via the network NW by a communication unit, which is not illustrated. Note that the mixed sound signal including the perturbation may be compressed to reduce the amount of data during transmission.

For example, the reproduction device 3A performs processing of reproducing the mixed sound signal X. Furthermore, for example, the reproduction device 3B performs sound source separation processing on the mixed sound signal X to separate the mixed sound signal X into separation signals S₁ to S₃. The separation signal can be used for up-mixing such as multi-channel reproduction and virtual surround, remixing such as extraction and reproduction of only a specific sound, karaoke, or the like.

### [Configuration Example of Reproduction Device]

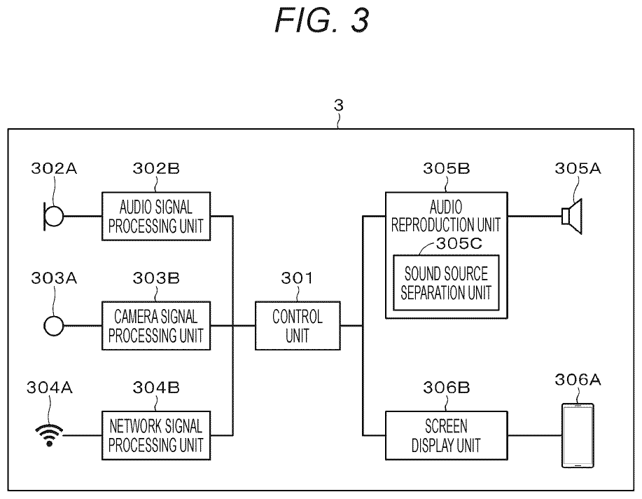

FIG. 3 is a block diagram illustrating a configuration example of the reproduction device 3 (more specifically, the reproduction device 3B) according to the first embodiment. Note that, in the present embodiment, the reproduction device 3A will also be described as having a configuration similar to that of the reproduction device 3B, but the reproduction device 3A may have a configuration different from that of the reproduction device 3B. For example, the reproduction device 3A may not have the configuration related to the sound source separation processing.

The reproduction device 3 includes a control unit 301, a microphone 302A, an audio signal processing unit 302B connected to the microphone 302A, a camera unit 303A, a camera signal processing unit 303B connected to the camera unit 303A, a network unit 304A, a network signal processing unit 304B connected to the network unit 304A, a speaker 305A, an audio reproduction unit 305B connected to the speaker 305A, a display 306A, and a screen display unit 306B connected to the display 306A. Each of the audio signal processing unit 302B, the camera signal processing unit 303B, the network signal processing unit 304B, the audio reproduction unit 305B, and the screen display unit 306B is connected to the control unit 301.

The control unit 301 includes a central processing unit (CPU) and the like. The control unit 301 includes a read only memory (ROM) that stores a program, a random access memory (RAM) that is used as a work area when the program is executed, and the like (illustration of these components is omitted). The control unit 301 integrally controls the reproduction device 3.

The microphone 302A collects a user's utterance and the like. The audio signal processing unit 302B performs known audio signal processing on audio data of a sound collected via the microphone 302A.

The camera unit 303A includes an optical system such as a lens, an imaging element, and the like. The camera signal processing unit 303B performs image signal processing such as analog to digital (A/D) conversion processing, various correction processing, and object detection processing on an image (which may be a still image or a moving image) acquired via the camera unit 303A.

The network unit 304A includes an antenna and the like. The network signal processing unit 304B performs modulation/demodulation processing, error correction processing, and the like on data transmitted/received via the network unit 304A.

The audio reproduction unit 305B performs processing for reproducing a sound from the speaker 305A. The audio reproduction unit 305B performs, for example, amplification processing and D/A conversion processing. Further, the audio reproduction unit 305B performs processing of generating a sound to be reproduced from the speaker 305A. Furthermore, the audio reproduction unit 305B includes a sound source separation unit 305C. The sound source separation unit 305C performs sound source separation on a mixed sound signal obtained by mixing a plurality of sound source signals and further mixing a perturbation optimized to improve performance of the sound source separation. Note that, in a case where the mixed sound signal X is reproduced, that is, in a case where the sound source separation is not performed, the control unit 301 performs control not to operate the sound source separation unit 305C. Part of the separation signals which have been subjected to the sound source separation may be reproduced from the speaker 305A, or each separation signal may be stored in an appropriate memory.

As the display 306A, a liquid crystal display (LCD) or an organic electro luminescence (EL) display can be applied. The screen display unit 306B performs known processing for displaying various types of information on the display 306A. Note that the display 306A may be configured as a touch panel. In this case, the screen display unit 306B also performs processing of detecting an operation position of a touch operation or the like.

### [Operation of Perturbation Acquisition Unit]

Next, processing performed by the perturbation acquisition unit 21 according to the present embodiment (processing of obtaining the perturbation η) will be described.

A consideration will be given to a sound source separator that separates each sound source signal

$$f ( X ) = \hat{S} = [ {\hat{S}}_{1} , … , {\hat{S}}_{N} ]$$

from a mixed sound signal

$$X = {Σ}_{n} {s}_{n}$$

of N sound source signals

$$S = [ {s}_{1} , … , {s}_{N} ]$$

In general, the sound source separator includes a separation error, and the smaller the error, the better the sound quality of the separated sound source signal. In addition, the error tends to increase as the sound source separator becomes a simpler model that can be processed by more reproduction devices.

As shown in the following Expression (1), a consideration will be given to minimization of a loss function (separation error) L by addition of a minute perturbation η to the mixed sound signal.

$${min}_{η} {‖ S - f ( X + η ) ‖}^{2} = {min}_{η} L \qquad ( Expression 1 )$$

The minimization problem represented by Expression (1) can be obtained using a stochastic gradient method with respect to the perturbation η in a case of a differentiable model such as a case where the sound source separation is constituted by a neural network. In a case where the sound source separator is designed in a frequency domain, a target signal of Expression (1) is a spectrogram |STFT(S)| of s. Meanwhile, it is not preferable that the perturbation η be perceived by the user as a noise. Therefore, the perturbation η is set so as to be difficult to perceive with respect to the mixed sound signal X. There is a low possibility that the perturbation η diverges by the above optimization, but the obtained perturbation η is not necessarily difficult to perceive. Therefore, as shown in the following Expression (2), a regularization term [symbol] (X, η)
for making the perturbation η difficult to perceive is added.

$$L ( η ) = {‖ S - f ( X + η ) ‖}^{2} + λ ( X , η ) \qquad ( Expression 2 )$$

λ in Expression (2) is a weight parameter for adjusting the strength of regularization. The perceptibility of the perturbation η depends on the mixed sound signal X. In the present embodiment, as an example, the perturbation η is set on the basis of an auditory psychological model. According to the auditory psychological model, it is known that, due to masking effects in a time direction and a frequency direction, a signal component at a certain time frequency is masked by a larger signal component adjacent to the signal component in time or on a frequency axis, and is difficult to perceive. The magnitude of the signal to be masked is determined by a temporal deviation degree and a frequency, a deviation degree between a masker frequency and a maskey frequency, a signal level ratio, and the like. Since it takes time to strictly consider these auditory psychological models in each iteration of the stochastic gradient method, it is possible to consider a constraint condition considering masking effects that can be calculated at high speed. By using a short-time Fourier transform (STFT),

$$( X , η ) = ‖ \frac{P ( \vert STFT ( η ) \vert , k , t )}{P ( \vert STFT ( X ) \vert , k , t )} ‖$$

It is possible to use a regularization term in which the masking effects are approximately taken into consideration.

Note that P(Y,k,t)
is a two-dimensional convolution with respect to an object to be convolved (spectrogram Y in this example), where k represents a kernel and t represents a stride.

For example, when k is a kernel having a size

$${k}_{1} \times {k}_{2}$$

and an element

$$\frac{1}{{k}_{1} {k}_{2}}$$

and t is

$${k}_{1} \times {k}_{2}$$

it is possible to implement the regularization term as average pooling of the size

$${k}_{1} \times {k}_{2}$$

Note that a Gaussian kernel or the like may be used as k. Furthermore, the division indicates division for each element.

The weight parameter λ can implement the target separation error
L_{target}
and η is obtained as a minimum value that makes it difficult to perceive (X and X+η are difficult indistinguishable as much as possible). The weight parameter λ can be expressed by the following Expression (3).

$${λ}_{opt} = {min}_{λ ∈ Λ} λ , Λ = \{ λ \vert {L}_{min} ( λ ) < {L}_{target} and {E}_{X} [ p ( X + {η}_{X} ) ] ∼ 0.5 \} \qquad ( Expression 3 )$$

In Expression (3), p (x) is a probability that x is determined not to include a noise signal, and is obtained on the basis of subjective evaluation or a statistical model. In this example, p (x) is set to 0.5 (50%).
η_{X}
is a minute signal obtained for the input X, and
E_{X}
is an expected value for X,
Lₘᵢₙ (λ)
is a value of an error obtained using λ.

As described above, the perturbation acquisition unit 21 acquires the perturbation η by performing learning so as to minimize the loss function L (η).

According to the present embodiment, it is possible to improve the performance of the sound source separation processing without changing the sound source separation model on the reproduction device 3 side. In addition, it is not necessary to use auxiliary information for improving the accuracy of the sound source separation model. That is, conventionally, in a case where the auxiliary information cannot be reproduced for some reason, the accuracy of the sound source separation model cannot be improved, but such a problem does not occur in the present embodiment.

By the way, the perturbation η calculated by the above-described method particularly improves only the separation performance of the sound source separation model used at the time of calculation, and the separation performance of another sound source separation model tends not to greatly change. By using this property, it is possible to improve the performance of the sound source separation based on the sound source separation model by optimizing the perturbation η for a specific sound source separation model. Furthermore, by applying a constraint during the perturbation calculation so as not to improve the performance of the sound source separation based on another sound source separation model, it is possible to emphasize the property of improving the performance of only a specific sound source separation model. This point will be described below.

Provided that a sound source separator whose performance is not desired to improve is
g₁, . . . , g_{M}
the loss function L (η) when the perturbation η is acquired is expressed by the following Expression (5).

$$L ( η ) = {‖ S - f ( X + η ) ‖}^{2} + λ ( X , η ) - {Σ}_{m} {λ}_{m} {‖ S - {g}_{m} ( X + η ) ‖}^{2} \qquad ( Expression 5 )$$

By setting the loss function L (η) as Expression (5), the perturbation η that improves the performance of the sound source separator f, while not improving the performance of another sound source separator.
g₁, . . . , g_{M}

Provided that

$${λ}_{m} > 0$$

and by setting the value to be 1/M or less, it is possible to maintain the effects of improving the performance of the sound source separator f.

In a case where it is desired to improve the performance of the sound source separation of, not one sound source, but a plurality of sound source separators
f₁, . . . , f_{K}
it can be achieved by generalizing the above-described Expression (5) as the following Expression (6).

$$L = {Σ}_{k} {α}_{k} {‖ S - {f}_{k} ( X + η ) ‖}^{2} + λ ( X , η ) - {Σ}_{m} {λ}_{m} {‖ S - {g}_{m} ( X + η ) ‖}^{2} \qquad ( Expression 6 )$$

Provided that

$${α}_{k} > 0$$

### Second Embodiment

Next, a second embodiment is described. Note that, in the description of the second embodiment, configurations that are identical or similar to those in the above-described first embodiment are denoted by identical reference signs, and redundant description will be appropriately omitted. In addition, the matters described in the first embodiment can be applied to the second embodiment unless otherwise specified.

When the sound source separation processing is performed by a reproduction device such as a smartphone, the processing capability may be greatly different depending on the type of the reproduction device. On the other hand, when a unified sound source separator is distributed to a plurality of types of reproduction devices by an application or the like, it is necessary to reduce the scale of the sound source separation model to reduce a load so that sound source separation can be performed by a reproduction device having a low processing capability. However, a reproduction device with abundant processing capability is capable of performing sound source separation with higher sound quality, but the performance of the sound source separation is degraded.

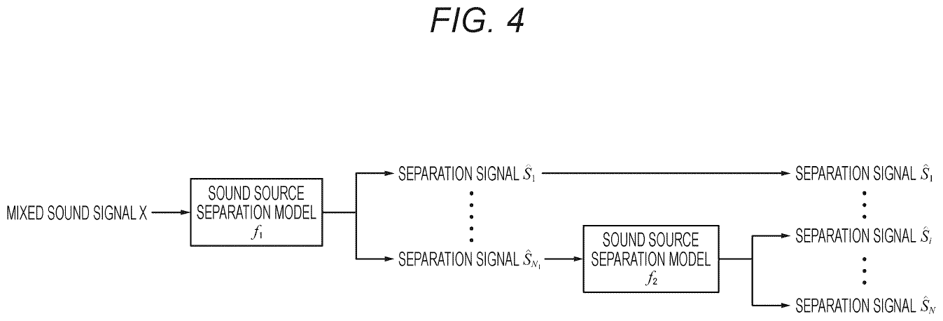

In view of the above, a consideration will be given to polarization of the number of separated sound sources by the sound source separation processing according to the processing capability of the reproduction device. A configuration for performing the sound source separation processing may be as illustrated in FIG. 4. In the example illustrated in FIG. 4, a sound source separation model f₁ separates a predetermined separation signal (separation signal) and a separation signal in which another sound source signal is mixed from the mixed sound signal X. In a reproduction device having high processing capability, a sound source separation model f₂ takes another sound source signal as input and further separates N sound source signals. With such a configuration, it is possible to determine a trade-off between the number of separated sound sources and the calculation amount for each reproduction device. In the example illustrated in FIG. 4, by optimizing the perturbation η for the sound source separation model f₁ and the sound source separation model f₂ having different sound source separation numbers, it is possible to improve both the performance of the sound source separation based on the sound source separation model f₁ and the performance of the sound source separation based on the sound source separation model f₂. Note that the optimization in this example includes setting the perturbation η such that a perturbation for improving the performance of the sound source separation based on the sound source separation model f₂ remains even after the sound source separation processing based on the sound source separation model f₁ is performed.

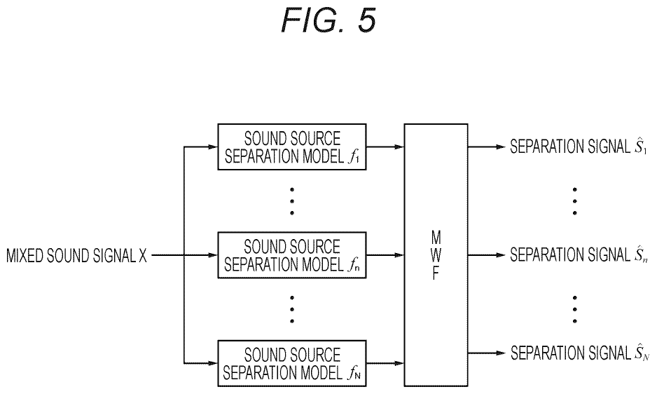

Furthermore, as illustrated in FIG. 5, the sound source separation processing can also be performed on the mixed sound signal X by a plurality of different sound source separation models. An example of the plurality of sound source separation models illustrated in FIG. 5 is a sound source separation model of sound source separation performed in parallel for the mixed sound signal X. Sound source separators corresponding to respective separation targets
f₁, . . . , f_{K}
are arranged in parallel. A processing result based on the sound source separation model is output via a multi-channel Wiener filter (MWF), whereby a separation signal is obtained. Also in the case of the present example, by obtaining the perturbation η so as to improve the performance of all the sound source separation models, it is possible to improve the performance of the sound source separation in any device having any processing capability. The perturbation η can be obtained by the following Expression (7).

$$L = {\sum }_{k} {α}_{k} {‖ {S}_{k} - {f}_{k} ( {X}_{k} + η ) ‖}^{2} + λ ( X , η ) \qquad ( Expression 7 )$$

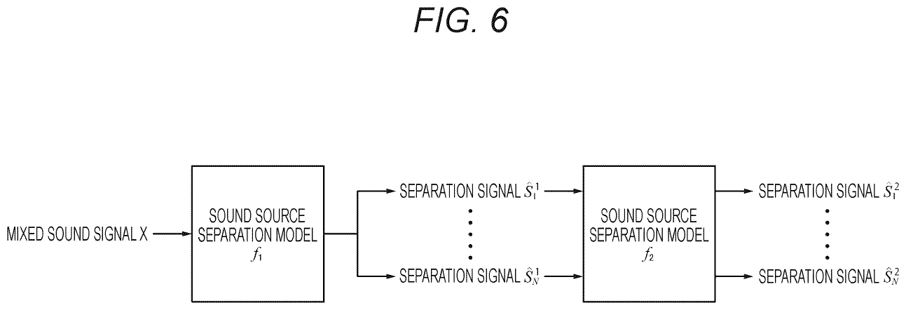

Furthermore, as illustrated in FIG. 6, although the number of separated sound sources and the type of sound sources to be separated are fixed, the sound source separator can be configured such that the separation processing is divided into a plurality of stages and the output of each stage is close to a target sound source. To which stage the separation processing is performed is determined according to the processing capability of the device. In the example illustrated in FIG. 6, the sound source separation processing based on the sound source separation model f₁ is performed on the mixed sound signal x, and the sound source separation processing based on the sound source separation model f₂ is performed on a result of the sound source separation based on the sound source separation model f₁. Also in this example, the perturbation η that improves the performance of the sound source separation can be obtained in any stage of the sound source separation processing. Such a perturbation η can be obtained by the following Expression (8).

$$L = {\sum }_{k = 1}^{K} {α}_{k} {‖ S - {f}_{k} ( {f}_{k - 1} , X + η ) ‖}^{2} + λ ( X , η ) \qquad ( Expression 8 )$$

Provided that f₀ is an empty set and is excluded from the input.

### Third Embodiment

Next, a third embodiment will be described. Note that, in the description of the third embodiment, configurations that are identical or similar to those in the above-described first and second embodiments are denoted by identical reference signs, and redundant description will be appropriately omitted. In addition, the matters described in the first and second embodiments can be applied to the third embodiment unless otherwise specified.

According to the methods described in the first and second embodiments, it is possible to implement high-quality sound source separation by sound source separation processing with a relatively small calculation amount. Here, perturbation calculation and the processing of mixing the perturbation with the mixed sound signal may be regarded as encoding processing, and the separation processing may be regarded as decoding processing, which can be regarded as a codec that compresses a multi-channel sound source to a small number of channels. There is an advantage that the mixed sound signal to which the perturbation η is added can be heard as it is without being decoded, and compression can be performed by another codec.

Here, a consideration will be given to application of the above-mentioned method to object audio. The object audio means a system that records a sound source and reproduction position information of the sound source and that reproduces a sound source signal so as to reproduce a spatial extent on the basis of the reproduction position information of the sound source signal when the sound source signal is reproduced. There are codecs for object audio such as MPEG-H which is a standard that supports such a system, but a communication amount also increases as the number of channels increases. Therefore, the present technology can further reduce the communication amount in combination with MPEG-H or the like. Furthermore, in the MPEG-H, encoded data can be reproduced only by a dedicated decoder, but in the present technology, even in a mixed state, the data can be heard as a normal stereo sound source, for example.

When spatial reproduction is performed using a result of the sound source separation, reproduction position information of the separated sound source is required. This can be comprehensively determined in advance depending on a type of a sound source, but there may be a situation where a creator wants to determine the reproduction position information for each sound source signal. In this case, in general, it is necessary to transmit the reproduction position information as a separate file from the sound source signal. According to such a system, the communication amount can be reduced, but a decoder of MPEG-H is required for reproduction. Therefore, a consideration will be given to embedding of also the reproduction position information of the sound source in the sound source as audio data.

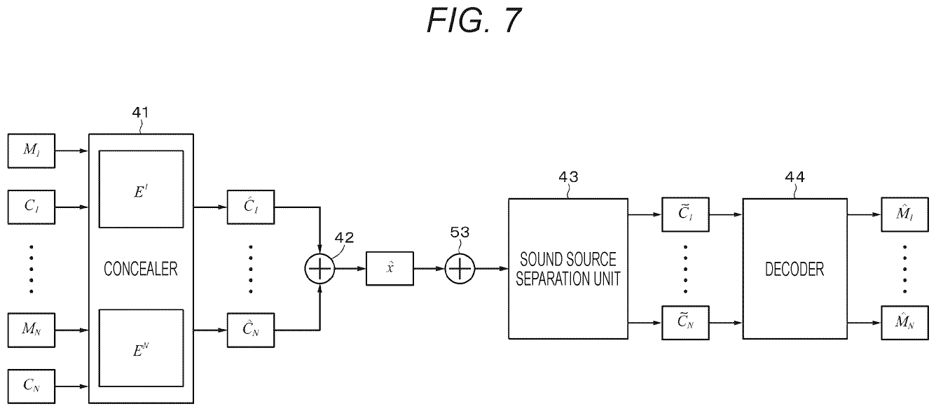

FIG. 7 is a diagram illustrating a concept of a reproduction system. Assume that N sound source signals and additional information such as reproduction position information for each sound source signal are

$$C = [ {c}_{1} , … , {c}_{N} ] \\ M = [ {m}_{1} , … , {m}_{N} ]$$

respectively.

A concealer 41 embeds additional information in the sound source signal. Specifically, a concealer Eₑ, to which C and M are input, outputs the following sound source signal in which additional information is embedded.

$$\hat{C} = [ {\hat{c}}_{1} , … , {\hat{c}}_{N} ] = {E}_{θ} ( C , M )$$

A mixed sound signal
\hat{X}
obtained by addition of a sound source signal
Ĉ
by the adder 42 is transmitted.

The transmitted mixed sound signal is subjected to sound source separation by the sound source separation unit 43, whereby

$$\hat{C} = [ {\hat{c}}_{1} , … , {\hat{c}}_{N} ]$$

as a separation signal is obtained.

A decoder 44 decodes (extracts) additional information

$$\hat{M} = [ {\hat{m}}_{1} , … , {\hat{m}}_{N} ] = {D}_{φ} ( \tilde{C} )$$

from the separation signal.

Herein, the concealer 41 and the decoder 44 are trained so that an error of
Ĉ
from C becomes small so as to be difficult to perceive by applying a constraint so that additional information
\hat{M}
decoded by the decoder 44 becomes close to original information M. A learning model obtained as a result of learning is applied to each of the concealer 41 and the decoder 44.

The additional information can be embedded as shown in the following Expression (9) by using a concealer
E_{θ}ⁱ
with respect to each sound source signal cᵢ and additional information Mᵢ.

$${\hat{c}}_{i} = {E}_{θ}^{i} ( {c}_{i} , {M}_{i} ) \qquad ( Expression 9 )$$

Similarly, the decoder 44 can obtain the additional information expressed by the following Expression (10) for each sound source signal.

$${\hat{m}}_{i} = {D}_{φ}^{i} ( {\tilde{c}}_{i} ) \qquad ( Expression 10 )$$

The learning model applied to the concealer 41 and the decoder 44 is obtained by minimizing the following loss function (Expression (12)) as shown in Expression (11), specifically, by optimizing the loss function using, for example, a stochastic gradient method.

$$\begin{matrix}{min}_{θ , φ} [ L ( θ , φ , M , C ) ] , & ( Expression 11 ) \\ L ( θ , φ , M , C ) = {Σ}_{i} {λ}_{1} ‖ {c}_{i} - {E}_{θ}^{i} ( {c}_{i} ) ‖ + {λ}_{2} ‖ {M}_{i} - {D}_{φ}^{i} ( f ( {Σ}_{j} {E}_{θ}^{j} ( {c}_{j} ) ) ) ‖ + {λ}_{3} ‖ {c}_{i} - {f ( {Σ}_{j} {E}_{θ}^{j} ( {c}_{j} ) )}_{i} ‖ & ( Expression 12 )\end{matrix}$$

Provided that [symbol]
is a set of sound sources, and [symbol]
is a set of additional information.

Here, when the sound source separation performance is low, the accuracy of the separation signal

$${\tilde{c}}_{i} = f ( {\hat{c}}_{i} )$$

separated by the sound source separation model f decreases, and it may be difficult to decode the additional information mᵢ from the separation signal. Therefore, the accuracy of sound source separation is improved by adding the perturbation η described in the first embodiment to the mixed sound signal.

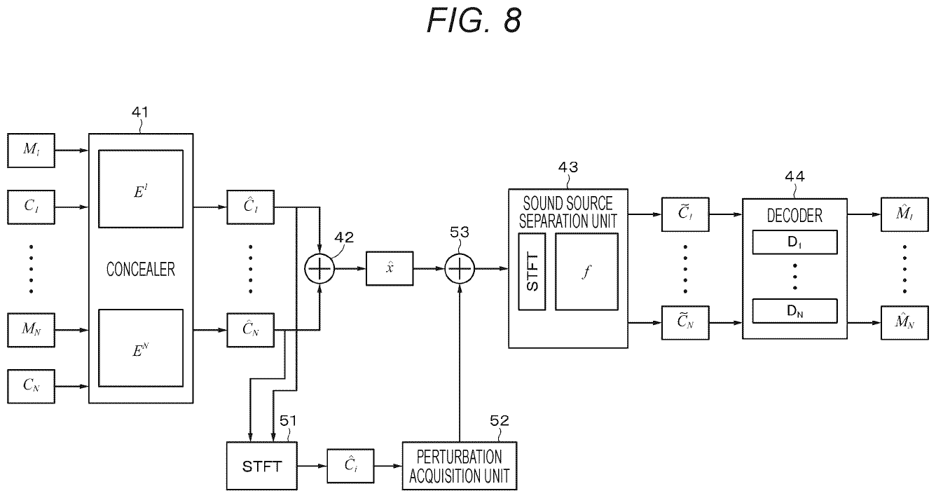

For example, as illustrated in FIG. 8, the sound source signal in which the additional information is embedded by the concealer 41 is converted into a signal in a frequency domain by a STFT unit 51. The output of the STFT 51 is supplied to the perturbation acquisition unit 52. Furthermore, STFT is performed on the separation signal subjected to the sound source separation by the sound source separation unit 43, and a result thereof is supplied to the perturbation acquisition unit 52. The perturbation acquisition unit 52 minimizes an error between the signal supplied from the STFT 51 and the signal supplied from the sound source separation unit 43, and obtains the perturbation η that makes it difficult for the user to perceive. The obtained perturbation η is added by the adder 53 to the mixed sound signal obtained by mixing the sound source signal in which the additional information is embedded. The loss function for obtaining the perturbation η can be expressed by the following Expression (13).

$$L ( θ , φ , η ) = {\sum }_{i} {λ}_{1} ‖ {c}_{i} - {E}_{θ}^{i} ( {c}_{i} ) ‖ + {λ}_{2} ‖ {M}_{i} - {D}_{φ}^{i} ( f ( {Σ}_{j} {E}_{θ}^{j} ( {c}_{j} ) ) ) ‖ + {λ}_{3} ‖ {\hat{c}}_{i} - {f ( {Σ}_{j} {E}_{θ}^{j} ( {c}_{j} ) + η )}_{i} ‖ + {λ}_{4} {STPR}_{} ( η , x ) \qquad ( Expression 13 )$$

For example, it is possible to efficiently calculate a parameter θ of the concealer 41 and a parameter φ of the decoder 44 by obtaining the perturbation η for each sound source signal after obtaining the parameters θ and φ by Expression (11).

In the present embodiment, it is not necessary to mix the additional information with the audio signal, in other words, to transmit the additional information as a separate file, so that the communication amount in transmission can be suppressed.

### Example of UI

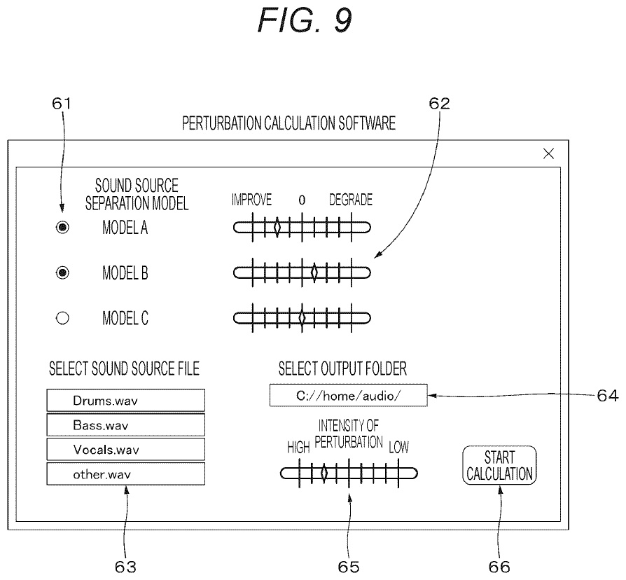

FIG. 9 illustrates an example of a user interface (UI) for calculating the perturbation η described in the first to third embodiments. The UI illustrated in FIG. 9 is displayed on a display device, for example.

The UI includes a display 61 capable of selecting a plurality of sound source separation models (for example, sound source separation models A to C). For example, by checking a radio button, a predetermined sound source separation model is selected. There may be a plurality of selectable sound source separation models. A bar 62 is displayed on the right side of each sound source separation model. By sliding a mark (rhombic mark in this example) in the bar 62, it is possible to improve or degrade the performance of the sound source separation by the corresponding sound source separation model.

Furthermore, the UI includes a display 63 for selecting a file of the sound source signal, a display 64 for designating an output folder that outputs a calculation result of the perturbation η, a bar display 65 for designating the intensity of the perturbation (for example, λ in Expression (2)), and a button display 66 for starting the calculation of the perturbation η. By using the UI illustrated in FIG. 9, the user can easily perform an operation of improving (or degrading) the accuracy of the specific sound source separation model or other operations.

### Application Example

The present disclosure enables the following application examples, for example.
The position reproduction setting information of the sound source signal is embedded in each sound source signal, and the separation signal subjected to the sound source separation can be spatially arranged and reproduced on the basis of the decoded reproduction position information.
Right information, performer information, and the like can be individually embedded in each sound source (guitars, vocals, drums, and the like).

### <Modification>

Although the embodiments of the present disclosure have been described above, the present disclosure is not limited to the above-described embodiments, and various modifications can be made without departing from the gist of the present disclosure.

All of the processing described in the embodiments need not be performed by the reproduction device. Part of the processing may be performed by a device different from the reproduction device, for example, a server. Furthermore, the additional information is not limited to the reproduction position information, and may be copyright information such as a type of a sound source, the number of reproducible times, and permission regarding secondary use.

Furthermore, the present disclosure can also be implemented by any mode such as a device, a method, a program, and a system. For example, a device, which can download a program for implementing the functions described in the above-described embodiments and which does not have the functions described in the embodiments, downloads and installs the program, and can thereby perform the control described in the embodiments. The present disclosure can also be implemented by a server that distributes such a program. Furthermore, the items described in each of the embodiments and the modification can be combined as appropriate. Furthermore, the contents of the present disclosure are not to be construed as being limited by the effects exemplified in the present specification.

The present disclosure may have the following configurations.

(1)

An information processing device includes a sound source separation unit that performs sound source separation on a mixed sound signal obtained by mixing a plurality of sound source signals and further mixing a perturbation optimized to improve performance of the sound source separation.

(2)

The information processing device according to (1), in which
the perturbation is set to be difficult to perceive with respect to the mixed sound signal.
   (3)

The information processing device according to (2), in which
the perturbation is set to be difficult to perceive with respect to the mixed sound signal on the basis of an auditory psychological model.
   (4)

The information processing device according to (1), in which
the perturbation is a perturbation optimized to improve performance of the sound source separation based on a specific sound source separation model.
   (5)

The information processing device according to any one of (1) to (4), in which
the perturbation is a perturbation optimized to improve performance of the sound source separation based on a plurality of different sound source separation models.
   (6)

The information processing device according to (5), in which
the plurality of sound source separation models are sound source separation models having different sound source separation numbers.
   (7)

The information processing device according to (5), in which
the plurality of sound source separation models are sound source separation models for sound source separation performed in parallel with the mixed sound signal.
   (8)

The information processing device according to (5), in which
the plurality of sound source separation models includes at least a first sound source separation model and a second sound source separation model, and
sound source separation processing based on the first sound source separation model is performed on the mixed sound signal, and sound source separation processing based on the second sound source separation model is performed on a sound source separation result based on the first sound source separation model.
   (9)

The information processing device according to any one of (1) to (8), in which
additional information of the sound source signal is mixed with the sound source signal as audio data.
   (10) The information processing device according to (9), in which
the additional information is information indicating a reproduction position of the sound source signal.
   (11)

The information processing device according to (9), further includes:
a decoder that reproduces additional information included in the sound source signal from the sound source signal subjected to the sound source separation by the sound source separation unit.
   (12)

An information processing device includes:
a perturbation acquisition unit that acquires a perturbation to be added to a mixed sound signal in which a plurality of sound source signals is mixed, in which
the perturbation acquisition unit acquires the perturbation by learning so as to minimize a separation error based on a difference between a predetermined sound source signal and a separation signal obtained by sound source separation from the mixed sound signal.
   (13)

The information processing device according to (12), in which
the separation error includes a regularization term for making the perturbation difficult to perceive.
   (14)

An information processing method includes:
a sound source separation unit performing sound source separation on a mixed sound signal obtained by mixing a plurality of sound source signals and further mixing a perturbation optimized to improve performance of the sound source separation.
   (15)

A program for causing a computer to execute an information processing method, the method includes:
a sound source separation unit performing sound source separation on a mixed sound signal obtained by mixing a plurality of sound source signals and further mixing a perturbation optimized to improve performance of the sound source separation.

### REFERENCE SIGNS LIST

2 Distribution device
3 Reproduction device
21 Perturbation acquisition unit
41 Concealer
43 Sound source separation unit
44 Decoder
52 Perturbation acquisition unit
305C Sound source separation unit

1. An information processing device comprising:
a sound source separation unit that performs sound source separation on a mixed sound signal obtained by mixing a plurality of sound source signals and further mixing a perturbation optimized to improve performance of the sound source separation.

2. The information processing device according to claim 1, wherein
the perturbation is set to be difficult to perceive with respect to the mixed sound signal.

3. The information processing device according to claim 2, wherein
the perturbation is set to be difficult to perceive with respect to the mixed sound signal on a basis of an auditory psychological model.

4. The information processing device according to claim 1, wherein
the perturbation is a perturbation optimized to improve performance of the sound source separation based on a specific sound source separation model.

5. The information processing device according to claim 1, wherein
the perturbation is a perturbation optimized to improve performance of the sound source separation based on a plurality of different sound source separation models.

6. The information processing device according to claim 5, wherein
the plurality of sound source separation models are sound source separation models having different sound source separation numbers.

7. The information processing device according to claim 5, wherein
the plurality of sound source separation models are sound source separation models for sound source separation performed in parallel with the mixed sound signal.

8. The information processing device according to claim 5, wherein
the plurality of sound source separation models includes at least a first sound source separation model and a second sound source separation model, and
sound source separation processing based on the first sound source separation model is performed on the mixed sound signal, and sound source separation processing based on the second sound source separation model is performed on a sound source separation result based on the first sound source separation model.

9. The information processing device according to claim 1, wherein
additional information of the sound source signal is mixed with the sound source signal as audio data.

10. The information processing device according to claim 9, wherein
the additional information is information indicating a reproduction position of the sound source signal.

11. The information processing device according to claim 9, further comprising:
a decoder that reproduces additional information included in the sound source signal from the sound source signal subjected to the sound source separation by the sound source separation unit.

12. An information processing device comprising:
a perturbation acquisition unit that acquires a perturbation to be added to a mixed sound signal in which a plurality of sound source signals is mixed, wherein
the perturbation acquisition unit acquires the perturbation by learning so as to minimize a separation error based on a difference between a predetermined sound source signal and a separation signal obtained by sound source separation from the mixed sound signal.

13. The information processing device according to claim 12, wherein
the separation error includes a regularization term for making the perturbation difficult to perceive.

14. An information processing method comprising:
a sound source separation unit performing sound source separation on a mixed sound signal obtained by mixing a plurality of sound source signals and further mixing a perturbation optimized to improve performance of the sound source separation.

15. A program for causing a computer to execute an information processing method, the method comprising:
a sound source separation unit performing sound source separation on a mixed sound signal obtained by mixing a plurality of sound source signals and further mixing a perturbation optimized to improve performance of the sound source separation.
